(19) United States
(12) Patent Application Publication
(10) Pub. No.: US 2023/0051673 A1
(43) Pub. Date: Feb. 16, 2023

(54) ORDER GROUPING AND PROCESSING METHOD FOR PERSONALIZED CUSTOM FURNITURE

(71) Applicant: DEHUA TB NEW DECORATION MATERIAL CO., LTD., Huzhou (CN)

(72) Inventors: Xianxu Zhan, Huzhou (CN); Xuqin Xie, Huzhou (CN); Rongrong Li, Huzhou (CN); Zhihui Wu, Huzhou (CN); Wei Xu, Huzhou (CN); Weida Xu, Huzhou (CN); Shixiong Sheng, Huzhou (CN); Ping Wang, Huzhou (CN)

(21) Appl. No.: 17/473,688

(22) Filed: Sep. 13, 2021

(30) Foreign Application Priority Data
Aug. 10, 2021 (CN) 2021109130424

(51) Int. Cl. G06Q 10/06; G06Q 30/06; G06Q 50/04

(52) U.S. Cl. CPC G06Q 10/06313; G06Q 30/0635; G06Q 30/0621; G06Q 50/04

(57) ABSTRACT

The disclosure belongs to the technical field of furniture processing and system planning, and in particular, to an order grouping and processing method for personalized custom furniture. The implementations of multi-order personalized custom furniture can be processed and produced efficiently through the manners of order sorting into sets, parts marking, parts grouping, parts sorting by order, and parts packaging by order in sequence.

### CROSS REFERENCE TO RELATED APPLICATION

This application claims priority to Chinese Patent Application No. 2021109130424, filed Aug. 10, 2021.

### TECHNICAL FIELD

The present disclosure belongs to the technical field of furniture processing and system planning, and in particular, to an order grouping and processing method for personalized custom furniture.

### BACKGROUND

Personalized custom furniture refers to the situation where there are differences in materials, structures, and dimensions among a plurality of orders of furniture, such that it leads to the complicated production process of this batch of furniture. The common production method of personalized custom furniture is processing by group, that is, the plurality of orders start production together, through adjusting the number of parts and the coordination of production steps, it is ensured that all the ordered products can be produced in the fastest and most economical way.

But on the other hand, most of the existing processing methods by group have the following problems to a certain extent.

First, the production efficiency is low. That is, the time required for the production of parts is not well controlled. For example, the production of part a has been completed, but the production of part b has not been completed, and the production will eventually be slowed down by part b.

Second, the material utilization rate is low. For example, when parts c, d, and e are originally produced together on a raw material board, a utilization rate of 90% can be achieved, but e and f use up a raw material board separately. As a result, the wood board materials left in the production of c and d are wasted.

Third, the sorting of parts is difficult. That is, a certain workshop is assigned to produce several kinds of plates of different sizes or even different materials, so it is very troublesome to select specific plate parts and need to go to high-intensity search.

Therefore, in summary, there is an urgent need for a reasonable and efficient multi-order custom furniture grouping processing method to ensure that each group can be processed and produced efficiently and economically within and among groups.

The Chinese disclosure patent with the patent publication number CN111754072A and the publication date of Oct. 9, 2020 discloses a batch combination optimization method and a system for improving the plate stacking rate, including: S101: obtaining group number m according to the order data of the current round of scheduled production consolidation, and dividing the order into P large groups based on the main material of the order; S102, obtaining the number n of small groups included in the large group, and dividing the large group into n small groups according to the upper limit of the number of grouped orders, the upper limit of the number of parts, and the similarity of the part size; S103, putting each unmarked group as a big order into the big order set, and combining the big orders into n′ groups according to the similarity of the part sizes among the big orders, the lower limit of the number of orders, and the upper limit of the number of parts; S104, forming production batch data according to the order grouping result.

However, the batch combination optimization method in that invention only considers the parameter of the plate size, but when adjusting the entire production method of a batch of multi-order custom furniture, it appears very inefficient, and there will still be the problem of non-synchronization of the production cycle among customized furniture parts, such that the efficiency of the entire processing and production process will be eventually made impossible.

### SUMMARY

The present disclosure provides an order grouping and processing method for personalized custom furniture, it is intended that the multi-order personalized custom furniture can be processed and produced efficiently through the methods of grouping orders into sets, parts marking, parts grouping, parts sorting by order, and parts packaging by order.

The technical solution adopted by the present disclosure to solve the above-mentioned problems is: an order grouping and processing method for personalized custom furniture comprises the following steps:

S1, sorting orders into sets: dividing all orders into a 1st set, a 2nd set, a 3rd set up to an Mth set according to different types of furniture materials, such that all orders in a single set have a same main material type; and then classifying the all orders in the single set by numbering, with number range of all orders is recorded as 1, 2, 3 up to N, such that order with number a-b is unique, where 1 [symbol] a [symbol] M, 1 [symbol] b [symbol] N;

S2, marking the parts: marking all parts in order a-b as a-b-1 to a-b-p, where p is a moment and [symbol] 1;

S3, grouping the parts: producing all the parts of all orders by groups with one or more reference indicators of a same process, a same size, a matching size, and an average area or a number of the parts, so as to improve a production efficiency of each group and balance a production speed among the groups;

S4, sorting the parts by the orders: sorting and summarizing all orders of the same set first, such that first numbers are the same after marking the parts; and then sorting and summarizing the parts of the same orders, such that second numbers are the same after marking the parts, and third numbers are required to be continuous after marking the parts;

S5; packing the parts according to the orders.

In the present disclosure, the key to improving the economy of the entire processing process is how to deploy the matching processing among various parts, and finally achieve the following two effects: first, the processing efficiency of each group itself should be high, and it is tried to ensure that the same material, the same size, and the same shape of the wood board parts are produced together, so that the board stacking rate and the veneer utilization rate will be greatly improved.

Second, the completion time among groups should be as the same as possible, and it cannot happen that one group will be processed quickly, but the other group's processing volume is too large and the production takes a long time, because it is the slowest production efficiency that determines the efficiency of the entire processing operation.

In a preferred embodiment, in S1, the personalized custom furniture comprises a customized wardrobe, a customized cabinet, a customized bed, and a customized TV bench; the materials comprise wood-grain veneer panels made of oak, pine, birch and beech.

In a preferred embodiment, in S1, a weight of a main material corresponding to the single set accounts for more than 60% of a total weight of single order materials.

In the present disclosure, a single order can contain a variety of different materials, but the weight of the main material accounts for 60%, so as to ensure that the subsequent parts are sorted by order step, avoiding the trouble and inefficiency when sorting and summarizing operations in multiple workshops.

In a preferred embodiment, in S2, dividing boundaries of the parts comprises hardware connection boundaries and clamping boundaries.

In the present disclosure, all the bonding operations must be completed before the parts leave the factory, and when the user orders arrive, the smell of the glue has been fully distributed, and the user does not need to perform large-scale bonding operations, such that the usage safety of user installation can be greatest ensured.

In a preferred embodiment, in S3, the process comprises a cutting process, an edge banding process, and an opening process, and the size comprises length and width.

In a preferred embodiment, in S3, the parts with the same process are grouped and produced together to improve production efficiency; through a manner of multi-part size matching, a yield rate of a fixed-size raw material board for a co-production of multi-part is achieved.

In a preferred embodiment, in S3, the average area refers to a sum of the area of all parts in each group, from small to large, denoted as S1-Sq; where Sq is 1.0-1.3 times of S1, and the average number of the parts refers to a sum of all parts in each group, from small to large denoted as r1-rq, where rq is 1.0-1.5 times of r1.

In a preferred embodiment, in S3, by adjusting the total area and/or number of each part group to balance a production cycle.

In the present disclosure, the grouping (or clustering) in S3 may have three meanings:

First, the same clustering. For example, boards of the same size can be stacked to improve efficiency;

Second, complementary clustering. For example, boards of different specifications can be opened in the same piece of raw material board to improve the utilization rate of the board;

Third, matching clustering. For example, in group 1: boards a and b, and group 2: boards c and d. The shape of the boards are different, and the matching cannot obviously improve the utilization of raw wood boards, but the time required for processing of group 1 is similar to that of group 2 after matching, such that the efficiency of the entire processing process can be ultimately improved.

In a preferred embodiment, in S4, at least one mobile sorting rack cart sorts and combines all the parts in each group according to an order information.

In a preferred embodiment, in S5, an order packing process adopts a fixed packaging method in which an upper and a lower layers are larger boards and at least one center layers are smaller boards, a long side size of the larger board is [symbol] 250 mm, a long side size of the smaller board is <250 mm, and the order number of a-b is provided on an outer packaging of the order, and an opening for the glue to ventilate.

In the present disclosure, the order number is provided on the outer packaging of the order, so as to facilitate the recognizability and traceability of the order in the subsequent storage scheduling process. The opening can ensure that when the user receives an order, the glue in the parts is in the smallest possible smell.

The present disclosure has the following advantages:

1, the order product is divided into parts, and the parts are grouped for production according to a plurality of division standards, so as to ensure that the parts in the same group are produced with high stacking rate, high utilization rate of raw materials and high overall production efficiency;

2, the processing cycle matching among groups is reasonable, shortening the entire processing cycle of all orders;

3, the overall planning of the grouping of parts is reasonable and efficient, the subsequent sorting and packaging operations are simple and convenient, and the final order is low in cost and high in quality. The delivery time is short.

### BRIEF DESCRIPTION OF DRAWINGS

FIG. 1 is a step diagram showing an order grouping and processing method according to the present disclosure.

### DESCRIPTION OF EMBODIMENTS

The following descriptions are only preferred embodiments of the present disclosure, and do not limit the scope of the present disclosure.

### Embodiment

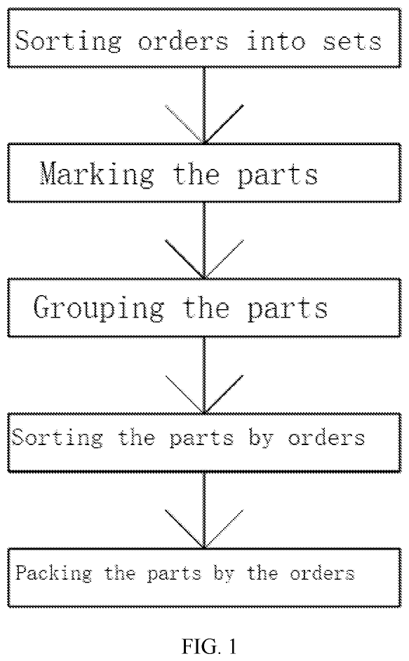

As shown in FIG. 1, an order grouping and processing method for personalized custom furniture may include the following steps in sequence:

S1, sorting orders into sets: dividing all orders into a 1st set, a 2nd set, a 3rd set up to an Mth set according to different types of furniture materials, such that all orders in a single set have a same main material type; and then classifying the all orders in the single set by numbering, with number range of all orders is recorded as 1, 2, 3 up to N, such that order with number a-b is unique, where 1 [symbol] a [symbol] M, 1 [symbol] b [symbol] N;

S2, marking the parts: marking all parts in order a-b as a-b-1 to a-b-p, where p is a moment and [symbol] 1;

S3, grouping the parts: producing all the parts of all orders by groups with one or more reference indicators of a same process, a same size, a matching size, and an average area or a number of the parts, so as to improve a production efficiency of each group and balance a production speed among the groups;

S4, sorting the parts by the orders: sorting and summarizing all orders of the same set first, such that first numbers are the same after marking the parts; and then sorting and summarizing the parts of the same orders, such that second numbers are the same after marking the parts, and third numbers are required to be continuous after marking the parts;

S5; packing the parts according to the orders.

In S1, the personalized customized furniture includes a customized wardrobe, a customized cabinet, a customized bed, and a customized TV cabinet, and the material types include wood-grain veneer panels made of oak, pine, birch, and beech.

In this embodiment, a single order can choose a variety of woods for two purposes:

first, to make the use environment and conditions of each part of the household product more compatible with the characteristics of the wood, and the service life of the entire household product can be greatly extended;

second, to meet the various diversified customization needs of customers.

In S1, the weight of the main material type corresponding to a single set accounts for more than 60% of the total weight of the single order material.

In S2, the dividing boundary of the part may include a hardware connection boundary and a clamping boundary.

In S3, the process may include a cutting process, an edge banding process, and an opening process, and the dimensions are length and width dimensions.

In this embodiment, the options for the edge banding process may include: stainless steel edge banding, plastic edge banding, and resin curing molding edge banding. The opening process may be mainly selected from a group consisting of a hole opening and a fixed hole opening. The equipment may be used for drilling holes and machining center holes.

In S3, the parts with the same process may be grouped and produced together to improve production efficiency, and the size of multiple parts may be matched to increase the yield rate of the fixed-size raw material board for the joint production of multiple parts.

In this embodiment, the size matching refers to classifying multiple parts boards into one group according to the existing known large-scale veneer size of raw materials, for example, 200*120 cm, and opening these part boards on one raw material veneer, such that a higher utilization rate of raw materials can be achieved. For example, three 120*60 cm door panels may be arranged horizontally, and four 50*10 cm partitions may be arranged in two rows and two columns, such that 98.3% utilization rate can be obtained in a raw material board with a dimension of 200*120 cm.

In S3, the average area refers to the sum of the area of all parts in each group, from small to large, recorded as S1-Sq, where Sq is 1.0-1.3 times of S1. The average number of parts refers to the sum of the number of parts in each group, from small to large, recorded as r1-rq, where rq is 1.0-1.5 times r1.

In the furniture processing and production process, the entire processing cycle is determined by the slowest part group. Therefore, coordinating the processing time required by each group is the key to ensuring that the shipment can be made as soon as possible, that is, to avoid some groups completing processing quickly and idle, some groups have too much workload, which leads to the problem of long processing time.

In this embodiment, the area of the parts may be the overall area of the board, which has a greater impact on the processing cycle than the number of parts. Therefore, the deviation threshold of the area of the parts among different groups may be 30%, and the number of parts may be 30%. The threshold value of the deviation between different groups may be 50%, which may be also the key to finally coordinating the processing cycle among different groups.

In S3, the production cycle of each component group may be balanced by adjusting the sum of the area and/or the number of each component group.

In this embodiment, at the beginning, the primary consideration criterion for the grouping of parts may be the type of wood. It is ensured that there is only one type of wood in a batch, and also avoid the problem of categorizing larger parts and smaller parts into a group, so as to avoid unnecessary trouble when sorting parts later.

In S4, at least one mobile sorting rack cart sorts and combines all the parts in each group according to the order information.

In this embodiment, the mobile sorting rack carts may be a rail transport vehicle with its own control program. According to the prior art, it cooperates with the operation of a personal or robot arm to complete the sorting operation of all parts in a complete order.

In S5, the order packaging process adopts the method of fixed packaging with the upper and lower layers being larger plates and the center layer being smaller plates. The long side dimension of the larger plate may be [symbol] 250 mm, and the long side dimension of the smaller plate may be less than 250 mm. There is an a-b order number on the package, as well as openings for the glue to ventilate.

In this embodiment, the long side of the order packaging may be controlled within 250 mm, and the packaging method with a larger outer side and a smaller middle may be used to improve the stability of the packaging structure and ensure that it is not easily damaged in the subsequent logistics process.

The embodiments of the present disclosure are described in detail above with reference to the accompanying drawings, but the present disclosure is not limited to the above-mentioned embodiments, and within the scope of knowledge possessed by a person of ordinary skill in the technical field, various modifications can also be made without departing from the purpose of the present invention. These are all modifications that are not inventive, as long as they are protected by the patent law within the scope of the claims of the present disclosure.

What is claimed is:

1. An order grouping and processing method for personalized custom furniture, wherein comprising the following steps:
S1, sorting orders into sets: dividing all orders into a 1^{st} set, a 2^{nd} set, a 3^{rd} set up to an Mth set according to different types of furniture materials, such that all orders in a single set have a same main material type; and then classifying the all orders in the single set by numbering, with number range of all orders is recorded as 1, 2, 3 up to N, such that order with number a-b is unique, where 1 [symbol] a [symbol] M, 1 [symbol] b [symbol] N;
S2, marking the parts: marking all parts in order a-b as a-b-1 to a-b-p, where p is a moment and [symbol] 1;
S3, grouping the parts: producing all the parts of all orders by groups with one or more reference indicators of a same process, a same size, a matching size, and an average area or a number of the parts, so as to improve a production efficiency of each group and balance a production speed among the groups;
S4, sorting the parts by the orders: sorting and summarizing all orders of the same set first, such that first numbers are the same after marking the parts; and then sorting and summarizing the parts of the same orders, such that second numbers are the same after marking the parts, and third numbers are required to be continuous after marking the parts;
S5; packing the parts according to the orders.

2. The order grouping and processing method for personalized custom furniture according to claim 1, wherein in S1, the personalized custom furniture comprises a customized wardrobe, a customized cabinet, a customized bed, and a customized TV bench; the materials comprise wood-grain veneer panels made of oak, pine, birch and beech.

3. The order grouping and processing method for personalized custom furniture according to claim 2, wherein in S1, a weight of a main material corresponding to the single set accounts for more than 60% of a total weight of single order materials.

4. The order grouping and processing method for personalized custom furniture according to claim 2, wherein in S2, dividing boundaries of the parts comprises hardware connection boundaries and clamping boundaries.

5. The order grouping and processing method for personalized custom furniture according to claim 1, wherein in S3, the process comprises a cutting process, an edge banding process, and an opening process, and the size comprises length and width.

6. The order grouping and processing method for personalized custom furniture according to claim 5, wherein in S3, the parts with the same process are grouped and produced together to improve production efficiency, through a manner of multi-part size matching, a yield rate of a fixed-size raw material board for a co-production of multi-part is achieved.

7. The order grouping and processing method for personalized custom furniture according to claim 1, wherein: in S3, the average area refers to a sum of the area of all parts in each group, from small to large, denoted as S1-Sq; where Sq is 1.0-1.3 times of S1, and the average number of the parts refers to a sum of all parts in each group, from small to large denoted as r1-rq, where rq is 1.0-1.5 times of r1.

8. The order grouping and processing method for personalized custom furniture according to claim 7, wherein: in S3, by adjusting the total area and/or number of each part group to balance a production cycle.

9. The order grouping and processing method for personalized custom furniture according to claim 1, wherein: in S4, at least one mobile sorting rack cart sorts and combines all the parts in each group according to an order information.

10. The order grouping and processing method for personalized custom furniture according to claim 1, wherein: in S5, an order packaging process adopts a fixed packaging method in which an upper and a lower layers are larger boards and at least one center layers are smaller boards, a long side size of the larger board is [symbol] 250 mm, a long side size of the smaller board is <250 mm, and the order number of a-b is provided on an outer packaging of the order, and an opening for the glue to ventilate.
